(19) United States
(12) Patent Application Publication
(10) Pub. No.: US 2006/0074812 A1
(43) Pub. Date: Apr. 6, 2006

(54) Code pack for revenue protection

(76) Inventor: James M. Mattern, Bethany, CT (US)

Correspondence Address: PERMAN & GREEN, 425 POST ROAD, FAIRFIELD, CT, 06824, US

(21) Appl. No.: 11/047,288

(22) Filed: Jan. 31, 2005

Related U.S. Application Data
(60) Provisional application No. 60/616,719, filed on Oct. 6, 2004.

(51) Int. Cl. G06F 17/60

(52) U.S. Cl. 705/60

(57) ABSTRACT

A method of verifying and protecting a software download includes constructing a first code pack as part of a software download, accessing the first code pack after the download has been provided, and comparing the first code pack against an internally generated code pack, and enabling the downloaded software if the code packs match.

The present invention claims the benefit of U.S. Provisional Application No. 60/616,719, filed Oct. 5, 2004, which is incorporated by reference herein in its entirety.

### BACKGROUND

The present invention relates to using software code to protect and verify a revenue generating software download.

### BRIEF DESCRIPTION OF RELATED DEVELOPMENTS

A high volume postal customer may use a meter which incorporates a Postal Security Device (PSD) to secure the proof of payment of postal indicia. The indicia is applied to mailing items that identifies the value of the postage applied and other information. The customer may purchase postage and the purchased value may be stored in the PSD. As the postage indicia is applied to items, the value applied may be deducted from the stored value. Once postage indicia is applied, the item may then be dropped into the collection stream of the particular postal system and subsequently processed for delivery.

In various countries, for example the United States, postal meters may communicate with a remote data center to have postage funds replenished. In the United States, a postal customer generally may add postage to the meter in two ways. The first is to physically take the meter to the postal authority, generally referred to herein as “the post,” where postage is purchased and added to the PSD. The second is to remotely add postage over a network, for example, a telephone line with a modem, or the Internet, where the added postage is deducted from an account usually maintained with a meter vendor or a trusted third party administrator, for example, a financial institution. In this case, customer or postal authority access to a meter's accounting system or memory system generally is not possible. Meters with this type of communication capability generally communication with a postal service provider data center to add funds or to reestablish authenticity. A communication cycle may be initiated automatically, or by a user of the meter.

Occasionally, a meter may require an update to its operating software, may be in need of an update or change to the ancillary services it provides (for example, postal rates), or generally may require a download of information of some type. For example, while postal equipment is generally extremely reliable, a meter failure may occur causing the user some inconvenience. When a program or other type of data needs to be installed to remedy the problem, a field repair is not practical due to the secure nature of the meter. Therefore, a replacement meter must be provided, further lengthening equipment “down time” for the customer. In the case of a postal meter, the failed device needs to be removed from service, the postal authority notified, a replacement unit logged with the postal authority, and the replacement unit must then be provided to the customer.

It is advantageous to supply services, upgrades, revisions, programs and generally provide information of various types through a remote downloading methodology and system that minimizes mailing or otherwise transporting software on physical media. There is a need to assure that a remote device is updated securely and properly, and that the update is valid, has originated from a valid source, and that device itself is eligible for the download.

### SUMMARY OF THE EXEMPLARY EMBODIMANTS

It is a feature of the exemplary embodiments for a server to provide one or more remote devices with software updates. As part of the update process, the server constructs software code, referred to as a code pack. After an update has been provided to a remote device, the device accesses the server code pack, compares it against an internally generated code pack, and enables the downloaded software if the code packs match.

### BRIEF DESCRIPTION OF THE DRAWINGS

The foregoing aspects and other features of the present invention are explained in the following description, taken in connection with the accompanying drawings, wherein:

FIG. 1 shows a block diagram of a system suitable for practicing the invention; and

FIG. 2 shows a remote device for operation within the system of FIG. 1.

### DETAILED DESCRIPTION OF THE PREFERRED EMBODIMENTS

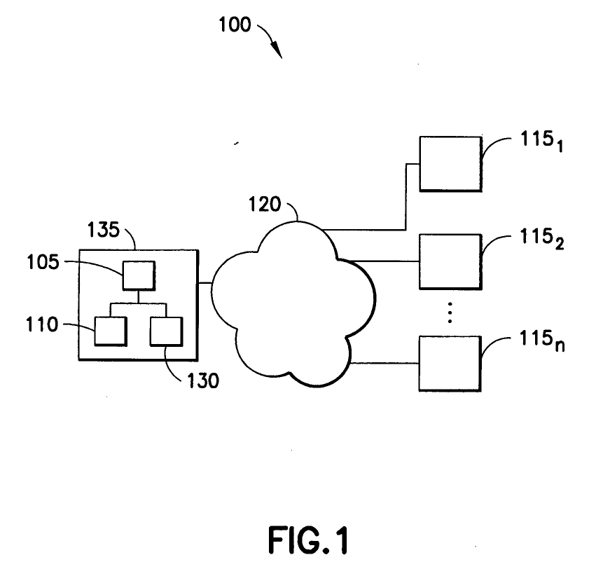

FIG. 1 shows a block diagram of a system suitable for practicing the invention disclosed herein. Although the present invention will be described with reference to the embodiment shown in the drawings, it should be understood that the present invention can be embodied in many alternate forms of embodiments. In addition, any suitable size, shape or type of elements or materials could be used.

System 100 is system for providing services, for example, a postal services provider system. System 100 includes one or more remote devices, for example, indicia producing or marking devices, shown in FIG. 1 as meters 115₁ . . . 115ₙ, and a remote data center, shown generally as a server 135.

It is a feature of the present invention for the server to provide the remote devices with revised information, updates, additional features, etc., referred to as downloads. As part of providing a download, software code, referred to as a code pack, is constructed. After the download has been provided, the remote device accesses the constructed code pack, compares it against an internally generated code pack, and enables the download if the constructed and internally generated code packs match.

Server 135 generally includes a processor 105, a memory 110, and a database 130 for storing information. Processor 105 generally operates under the control of programs stored in memory 110 to manage operations of server 135. As mentioned above, server 135 generally provides updates, programs that allow additional functionality, replacement programs, data tables, other data and information, referred to as downloads to remote devices 115₁ . . . 115ₙ. In addition, server 135 may collect data from remote devices 115₁. . . 115ₙ and provide reporting and accounting services.

Server 135 may be coupled to a data communications network 120. Data communications network 120 may include any suitable communications network, for example, the Public Switched Telephone Network (PSTN), a wireless network, a wired network, a Local Area Network (LAN), a Wide Area Network (WAN), virtual private network (VPN) etc. Server 135 may communicate with remote devices 115₁ . . . 115ₙ using any suitable protocol, or modulation standard, for example, X.25, ATM, TCP/IP, V34, V90, etc. When data communications network 120 is implemented as a wireless network, it generally incorporates an air interface utilizing any suitable wireless communication protocol or signaling techniques or standards, for example TDMA, CDMA, IEEE 802.11, Bluetooth, close range RF, optical, any appropriate satellite communication standards, etc.

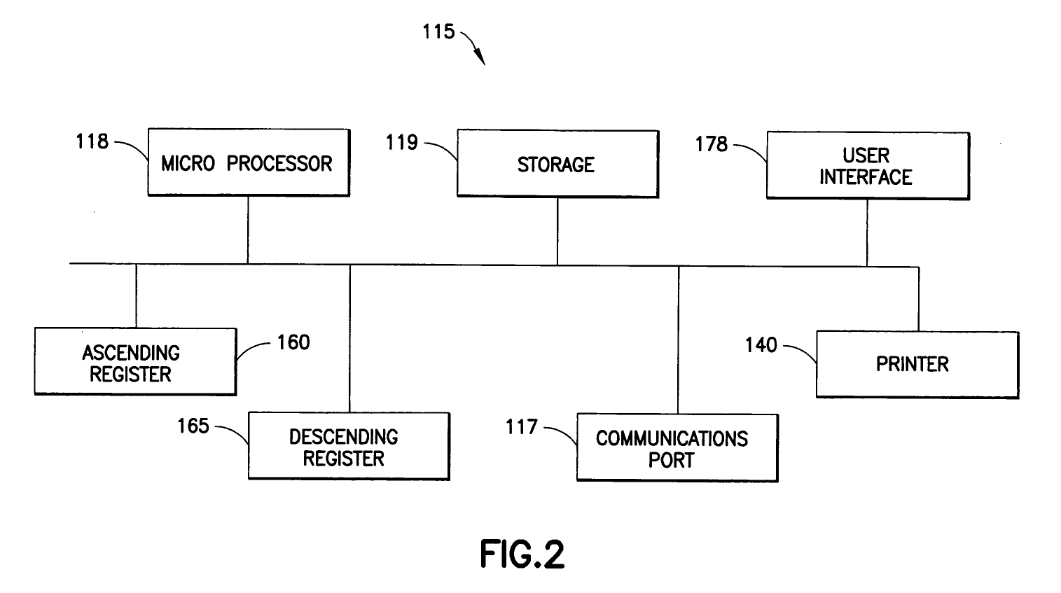

FIG. 2 shows a general block diagram of a remote device 115. Remote devices 115₁ . . . 115ₙ generally provide services to one or more customers. In one embodiment, the remote devices may provide indicia that has value, for example, postage, tickets allowing admission to an event or allowing the use of a service, etc. Remote device 115 may include a communications port 117 and a microprocessor 118 for performing accounting, control, and handling functions according to programs stored in a storage device 119. Some of these functions or subsets of these functions may be grouped within a secure perimeter as what is commonly referred to as a Postal Security Device (PSD).

Storage device 119 generally stores machine readable program code which is adapted to cause microprocessor 118 to perform functions associated with providing services, for example, producing indicia. Storage device 119 may utilize optical, magnetic, semiconductor, electronic, or other types of suitable devices to store the program code.

In the system of FIG. 1, a customer using a remote device generally has an account on the server 135. As part of the account, the server may store information specific to the remote device 115. Such information may include the MAC address of the remote device, user or customer information (name, company, phone, address, etc), the serial number, public key, customer upload information, options purchased by the customer, information related to an operating company that may be providing services to the remote device, and any other information specific to the remote device 115. The server may include additional information specific to the remote device and may assemble the specific information into an information bundle for the remote device 115 and store it in the server 135. A copy of the information bundle may also be assembled and stored in the remote device 115 as a local information bundle.

According to the exemplary embodiments, the server operates to provide the remote device 115 with a software download. Generally, during the download, the server operates on the server information bundle to create a server code pack. Such operations may include signing, encrypting, encoding, or other operations. The server code pack is delivered to the remote device as part of the download.

After the download, the remote device 115 may generally restart and application software in the device may operate on the local information bundle to create a local code pack. The application software in the device compares the local code pack with the server code pack, and if they are an exact match, the downloaded software is enabled. If the code packs do not match, then the application software may display a related message and may also generate a communication with the server 135 to provide a problem notification.

In another embodiment, the information bundles are assembled and the code packs are generated concurrent with or as part of the download process. For example, at the time a download is requested, the server 135 may gather the information specific to the remote device 115 and may optionally add additional information to create the information bundle, and may then operate upon the information bundle to create the code pack. The server may then download both the requested software and the sever code pack. Upon receiving the download, the remote device may then perform its own gathering operation and assemble a local information bundle at the time of the download, and then operate on the information bundle to create the local code pack.

After the download, the remote device 115 may generally restart and application software in the device may compare the local code pack with the server code pack, and if they are an exact match, the downloaded software may be enabled. Otherwise, if the code packs do not match, the application software may display an error message and generate an error message communication with the server 135.

In yet another embodiment, the download procedure may include a registration process. For example, at the remote device 115, a user may install software. The remote device may then prompt the user to register. The user may populate information fields, including for example, user information, an operating company identifier, etc. The remote device 115 may then store the information fields as part of the local information bundle and initiate a connection to the server 135 where the remote device uploads the registration information. At the server 135 the server may incorporate the registration information into the server information bundle then the download would proceed as described above.

In another embodiment, the remote device may periodically update its local information bundle and send it to the server 135. The server 135 may compare the remote device information bundle with information it stores regarding software versions, previous downloads, etc. to ensure a match, and may generate error messages upon detecting discrepancies

The disclosed exemplary embodiments may accommodate certain exceptions or errors that may occur during the download process, referred to as exception flows. For example, one exception flow may be initiated because a device's MAC address may have changed (new computer or device) where upon startup an application load fails. The remote device 115 may display instructions to a user regarding a probable cause. The remote device may then prompt for a re-registration and construct a new information bundle. The server may then receive the new information bundle and proceed as described above.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A method of verifying and protecting a software download comprising:
constructing a first code pack as part of downloading software;
accessing the first code pack after the download has been provided;
comparing the first code pack against an internally generated code pack, and enabling the downloaded software if the code packs match.
